(19) United States
(12) Patent Application Publication
(10) Pub. No.: US 2012/0044120 A1
(43) Pub. Date: Feb. 23, 2012

(54) PORTABLE TERMINAL ANTENNA FOR IMPROVING SAR AND HAC CHARACTERISTICS

(75) Inventors: Su-Hyun Choi, Gyeonggi-do (KR); Jun-Hee Kim, Incheon-si (KR); Won-Hwi Jin, Seoul (KR); Byong-Nam Kim, Gyeonggi-do (KR)

(73) Assignee: ACE TECHNOLOGIES CORPORATION, Incheon-si (KR)

(21) Appl. No.: 13/266,635

(22) PCT Filed: Apr. 28, 2010
(86) PCT No.: PCT/KR10/02698

§ 371 Date: Oct. 27, 2011

(30) Foreign Application Priority Data
Apr. 28, 2009 (KR) 10-2009-0037324

(51) Int. Cl. H01Q 9/06; H01Q 1/36

(52) U.S. Cl. 343/843; 343/700 MS

(57) ABSTRACT

An antenna for a mobile terminal for improving SAR and HAC characteristics is disclosed. The disclosed antenna may include: a first conductive line electrically connected to a feeding point; a second conductive line separated from the first conductive line at a designated distance and electrically connected to a ground; a third conductive line extending from the second conductive line; and a coupling branch separated from the third conductive line and electrically connected to a ground, where coupling matching and coupling feeding occur between the first conductive line and the second conductive line, and the second conductive line and the third conductive line operate as a radiator. The disclosed antenna can enable impedance matching for a broader band and can improve SAR and HAC characteristics.

### TECHNICAL FIELD

The present invention relates to an antenna, more particularly to an internal antenna applied to a mobile terminal

### BACKGROUND ART

Recently there has been a demand for the ability to receive mobile communication services of different frequency bands through one mobile communication terminal, even as mobile communication terminals become smaller and lighter.

An antenna, which is in charge of starting and finishing signal input and output in a base station and in a communication terminal, is a key component that determines the quality of communication, and entails a high level of difficulty in its design technology. Unlike other components, the antenna, especially a small antenna, entails the difficulty of requiring different suitable designs depending on the terminal, because the performance of the antenna varies according to the shape, functions, and material of the terminal in which the antenna is mounted.

In particular, there has been an increasing demand for multiple bands and broader bands with regards to an antenna in a mobile terminal, according to the trend in recent years toward providing services of various frequency bands through one mobile terminal

At the same time, specific absorption rate (henceforth, SAR), an index widely used for measuring the effects of electromagnetic waves emitted from mobile terminals on the human body, is regulated so as not to exceed a certain level. For instance, in Korea and the United States, the permitted level of SAR is 1.6 W/kg, while Europe and Japan have set the permitted level at 2.0 W/kg.

Accordingly, at the time of designing a mobile terminal, there is the added difficulty of having to meet the permitted SAR level along with the consideration of performance according to the shape, functions and material of the terminal

Moreover, the U.S. Federal Communications Commission (FCC) is making the move toward fortifying regulations dictating provision of hearing aid compatibility (henceforth, HAC) in mobile phones, so that those with hearing problems may not have difficulty using a mobile phone.

Accordingly, there is a demand for an antenna design that is able to satisfy the SAR and HAC requirements along with the basic requirements for quality communication in a mobile terminal

### DISCLOSURE

### [Technical Problem]

To resolve the problem of the related art addressed above, an aspect of the invention is to provide an internal antenna for a communication terminal that is able to improve SAR and HAC characteristics.

Another purpose of the present invention is to provide an internal antenna for a communication terminal that is able to improve SAR and HAC characteristics while fulfilling broad band and multiple band characteristics recently in demand

Other purposes of the present invention may be derived by those skilled in the art from the embodiments below.

### [Technical Solution]

To achieve the objective above, an aspect of the invention provides an antenna for a mobile terminal for improving SAR and HAC characteristics that comprises: a first conductive line electrically connected to a feeding point; a second conductive line separated from the first conductive line at a designated distance and electrically connected to a ground; a third conductive line extending from the second conductive line; and a coupling branch separated from the third conductive line and electrically connected to a ground, where coupling matching and coupling feeding occurs between the first conductive line and the second conductive line, and where the second conductive line and the third conductive line operate as a radiator.

The coupling branch is arranged such that coupling occurs from a point at least 0.15λ from the starting end of the radiator.

The coupling branch comprises a coupling part, in a designated section of which coupling with the third conductive line occurs, and a ground connection part, which is connected to the ground.

The coupling branch may further comprise an open stub for impedance matching.

Multiple open stubs protrude from the coupling branch and the third conductive line between them, in the section where coupling occurs between the coupling branch and the third conductive line.

The open stubs protruding from the coupling branch and the third conductive line protrude in an interlocking manner.

Multiple open stubs protrude from the first conductive line and the second conductive line between them.

Another aspect of the invention provides an antenna for a mobile terminal for improving SAR and HAC characteristics that comprises: a feeding part; a radiator configured to receive RF signals fed from the feeding part; and a coupling branch, electrically connected to a ground and separated from the radiator at a designated distance, in a section of which coupling with the radiator occurs.

### [Advantageous Effects]

The present invention allows impedance matching for a broad band, and can improve SAR and HAC characteristics.

### DESCRIPTION OF DRAWINGS

FIG. 1 is a drawing illustrating the structure of an antenna for a mobile terminal according to a first embodiment of the present invention.

FIG. 2 is a drawing illustrating the structure of an antenna for a mobile terminal according to a second embodiment of the present invention.

FIG. 3 is a drawing illustrating the structure of an antenna for a mobile terminal according to a third embodiment of the present invention.

FIG. 4 is a drawing illustrating the phenomenon of a beam pattern being altered by a coupling branch in an antenna according to a preferred embodiment of the present invention.

FIG. 5 is a drawing representing the beam pattern of an antenna for a mobile terminal according to an embodiment of the present invention as graphs.

FIG. 6 is a drawing representing electric field values over the front side of a mobile terminal when a coupling branch according to an embodiment of the present invention is used and when it is not used.

FIG. 7 is a drawing representing magnetic field values over the front side of a mobile terminal when a coupling branch according to an embodiment of the present invention is used and when it is not used.

### MODE FOR INVENTION

Preferred embodiments of an antenna for a mobile terminal for improving SAR and HAC characteristics according to an embodiment of the invention will be described below in more detail with reference to the accompanying drawings.

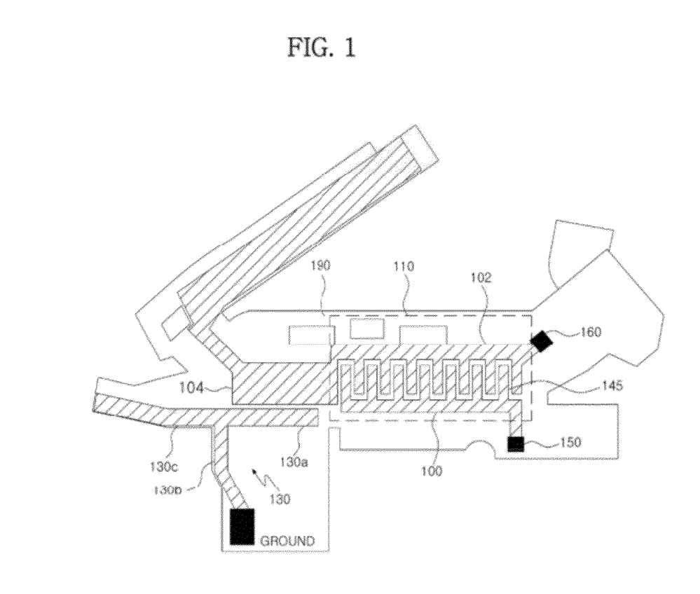

FIG. 1 is a drawing illustrating the structure of an antenna for a mobile terminal according to a first embodiment of the present invention.

Referring to FIG. 1, an antenna for a mobile terminal according to an embodiment of the present invention may include: an impedance matching/feeding part 110 comprising a first conductive line 100, electrically connected to a feeding point 150, and a second conductive line 102, electrically connected to the ground 160; a third conductive line 104, extending from the second conductive line 102 of the impedance matching/feeding part 100; and a coupling branch 130, placed at designated distance from the third conductive line.

The first conductive line 100 and the second conductive line 102, which compose the impedance matching/feeding part 110, are separated at a designated distance, and as described above, the first conductive line 100 is connected to the feeding point while the second conductive line 102 is connected to a ground.

Multiple open stubs 145 protrude from the first conductive line 100 and the second conductive line 102 into the space between the separated the first conductive line 100 and the second conductive line 102.

Traveling waves occur in the first conductive line 100 and the second conductive line 102, and coupling feeding from the first conductive line 100 to the second conductive line 102 is performed. The coupling that occurs between the first conductive line 100 and the second conductive line 102 enables impedance matching for a broader band than does direct feeding.

Here, the longer the section where coupling between the first conductive line 100 and the second conductive line 102 occurs, the broader the band for which impedance matching is achieved. This means that increasing the capacitance between the first conductive line 100 and the second conductive line 102 enables impedance matching for a broad band. Accordingly, in addition to making the lengths of the first conductor line 100 and the second conductor line 102 long, setting a small distance between the first conductive line 100 and the second conductive line 102 can also provide impedance matching for a broader band compared to those cases in which the distance is longer.

In FIG. 1, the open stubs 145 protruding from the first conductive line 100 and the second conductive line 102 actually increase the electrical lengths of the first conductive line 100 and the second conductive line 102. Accordingly, the protruding open stubs 145 allow impedance matching for a broader band.

Also, as illustrated in FIG. 1, the open stubs 145 protruding from the first conductive line 100 and the second conductive line 102 protrude in an interlocking manner. When the open stubs 145 interlock into each other in this manner, the distance between the first conductive line 100 and the second conductive line 102 decreases, thus providing a greater capacitance value during coupling matching, and accordingly, enabling impedance matching for a broader band.

Of course, when there are no spatial constraints for obtaining sufficient coupling space, the same effect may be achieved by setting the section for coupling between the first conductive line 100 and the second conductive line 102 to be long, even without the open stubs 145.

The second conductive line 102 and the third conductive line 104 extending from the second conductive line 102 act as a radiator. The radiating frequency of the antenna is determined by the lengths of the second conductive line 102 and the third conductive line 104. The lengths of the second conductive line 102 and the third conductive line 104 may be set to have approximately λ/4 of the length of the radiating frequency.

The coupling branch 130 comprises a coupling part 130a, which achieves coupling with the third conductive line, a ground connection part 130b, electrically connected to a ground, and a matching stub part 130c.

The coupling branch 130, placed at a designated distance from the third conductive line 104, has the function of altering the radiation pattern radiated by the radiator, which is composed of the second conductive line 102 and the third conductive line 104. In other words, the coupling branch 130 performs the role of tilting the radiation pattern, and it is possible to tilt the radiation pattern to reduce the radiation going toward the user of the mobile terminal and to increase the radiation going in the opposite direction from the user's body.

Coupling with the third conductive line 104 occurs in the coupling part 130a, which has to obtain a designated length for coupling, requiring a length of more than about 0.01λ. This may vary, however, according to the separating distance between the coupling part 130a and the third conductive line 104, the widths of the coupling part 130a and the third conductive line 104, and the frequency band used.

According to a preferred embodiment of the present invention, the coupling branch 130 is preferably placed such that its coupling with the radiator (the second conductive line and the third conductive line) is carried out at a point at least 0.15λ past the starting end of the radiator. If the coupling branch 130 is placed such that its coupling with the radiator takes place at a point less than 0.15λ past the radiator, the radiation frequency of the radiator may be altered, or in some cases unwanted parasitic resonance may occur. Therefore, the coupling branch can perform the beam pattern tilt function properly when its coupling with the radiator is carried out at a point at least 0.15λ past the radiator.

The ground connection part 130b is electrically connected to the ground, and the matching stub part 130c is open stubs for impedance matching.

The conductive lines and the coupling branch may be joined onto an antenna carrier 190.

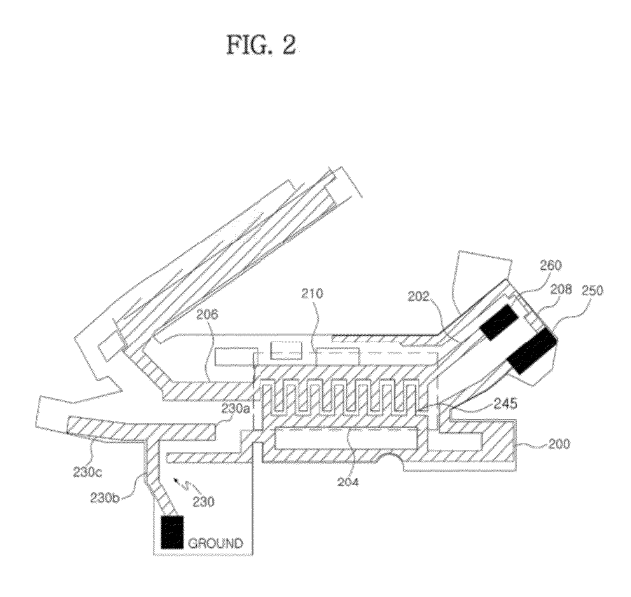

FIG. 2 is a drawing illustrating the structure of an antenna for a mobile terminal according to a second embodiment of the present invention.

Referring to FIG. 2, an antenna for a mobile terminal according to a second embodiment of the present invention may include: a first conductive line 200, connected to a feeding point 250 and with an end part that can be opened; a second conductive line 202, connected to a ground 260; a third conductive line 204, branching off from the first conductive line 200; a fourth conductive line 206, extending from the second conductive line 202; a fifth conductive line 208, connected to the feeding point in a direction different from the first conductive line 200; and a coupling branch 230.

Compared with the first embodiment in FIG. 1, the second embodiment is an antenna for a mobile terminal that performs radiation for triple bands, with two additional radiators.

The second conductive line 202 and the third conductive line 204 are placed at a designated distance apart from each other to perform the function of an impedance matching/feeding part 210 as in the first embodiment, while a coupling phenomenon occurs from the third conductive line 204 to the second conductive line 202. Multiple open stubs 245 protrude from the second conductive line 202 and the third conductive line 204 into the space separating the second conductive line 202 and the third conductive line 204.

Traveling waves occur in the second conductive line 202 and the third conductive line 204, and coupling feeding is achieved from the second conductive line 202 to the third conductive line 204. Coupling that occurs between the second conductive line 202 and the third conductive line 204 enables impedance matching for a broader band than does direct feeding.

The second conductive line 202 and the fourth conductive line 206 extending from the second conductive line 202 act as a first radiator. The first conductive line 200, connected to the feeding point and with an end part that can be opened, acts as a second radiator, and the fifth conductive line 208, connected to the feeding point and going in a direction different from the first conductive line, acts as a third radiator.

As illustrated in FIG. 2, the first radiator has the longest length and thus radiates signals of the lowest frequency band, and the third radiator has the shortest length and thus radiates signals of the highest frequency band.

In the second embodiment, the coupling branch 230 is placed at a designated distance away from the first conductive line 200 acting as the second radiator. The coupling branch 230 performs the function of beam pattern tilting as in the first embodiment, thereby improving SAR and HAC characteristics.

In other words, beam pattern tilting by the coupling branch 230 may be applied to any radiator when multiple radiators are used as in the second embodiment. In the second embodiment also, the coupling branch 230 is preferably placed such that its coupling with the first conductive line takes place at a point 0.15λ past the first conductive line (the second radiator).

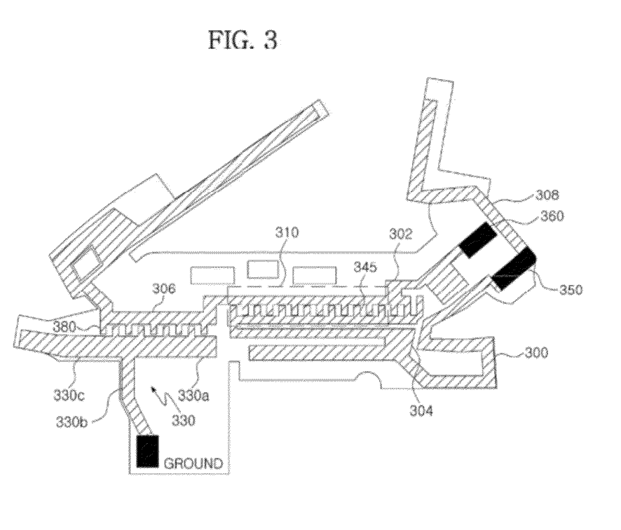

FIG. 3 is a drawing illustrating the structure of an antenna for a mobile terminal according to a third embodiment of the present invention.

Referring to FIG. 3, an antenna for a mobile terminal according to a third embodiment of the present invention may include: a first conductive line 300, connected to a feeding point and with an end part that can be opened; a second conductive line 302, connected to a ground; a third conductive line 304, branching off from the first conductive line 300; a fourth conductive line 306, extending from the second conductive line 302; a fifth conductive line 308, connected to the feeding point in a direction different from the first conductive line 300; and a coupling branch 330.

The third embodiment differs from the second embodiment in that the coupling branch 330 is arranged in such a manner that coupling occurs with the fourth conductive line 306, which is a part of the first radiator, and the length of the first conductive line 300, which is the second radiator, is set to be shorter than in the second embodiment.

In the third embodiment, multiple open stubs 380 protrude from the fourth conductive line 306 and the coupling branch 330 in the coupling section between the fourth conductive line 306 and the coupling branch 330.

The multiple open stubs protruding from the fourth conductive line 306 and the coupling branch 330, like the open stubs 345 protruding from the impedance matching part 310, perform the function of substantially increasing the electric length in the coupling section, and narrowing the gap between the fourth conductive line 306 and the coupling branch 330. The open stubs 380 protruding from the fourth conductive line 306 and the coupling branch are preferably made to interlock with each other also.

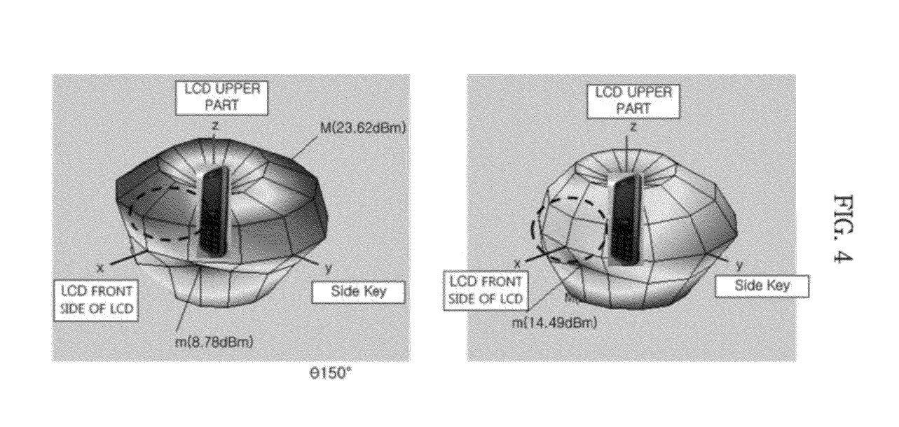

FIG. 4 is a drawing illustrating the phenomenon of a beam pattern being altered by a coupling branch in an antenna according to a preferred embodiment of the present invention.

In FIG. 4, the drawing on the left illustrates a beam pattern when a coupling branch is not used, and the drawing on the right illustrates a beam pattern when a coupling branch is used.

In the drawing on the left in FIG. 4, it may be confirmed that, when a coupling branch is not used, a large beam pattern forms at the front of the LCD, toward the head of the mobile terminal user. However, in the drawing on the right, it may be confirmed that, when a coupling branch is used, the beam power at the front of the LCD is decreased, but in the opposite direction toward the side keys, the beam power is increased, resulting from a beam pattern tilt. Moreover, it may also be confirmed from the beam pattern in FIG. 4 that, even if the beam power is decreased in any one direction, the overall beam power is not decreased.

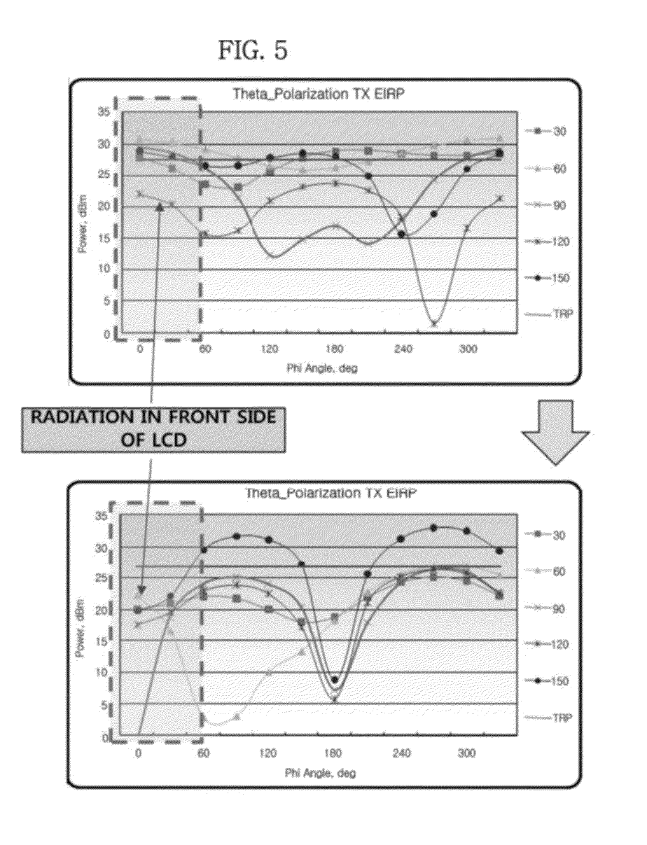

FIG. 5 is a drawing representing the beam pattern of an antenna for a mobile terminal according to an embodiment of the present invention as graphs.

In FIG. 5, the upper graph is of a beam pattern when a coupling branch is not used, and the lower graph is of a beam pattern when a coupling branch is used.

In FIG. 5, the x axis of each graph corresponds to the value φ in a spherical coordinate system, and graphically indicates the value of φ for when θ is 30, 60, 90, 120 and 150.

Also in FIG. 5, it may be confirmed that the power of φ, corresponding to the front side of LCD, is noticeably decreased when a coupling branch is used, and that a beam pattern tilt is created by a coupling branch.

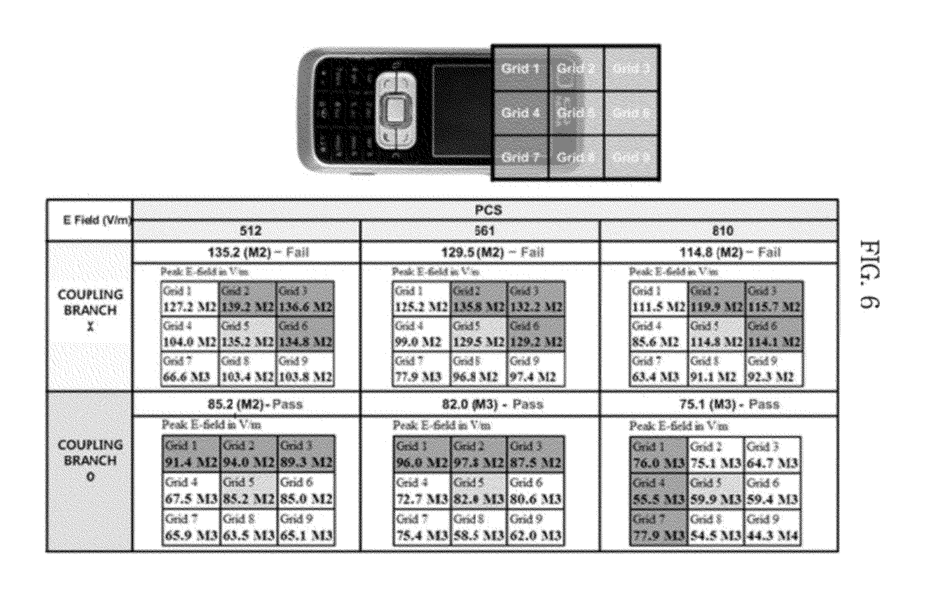

FIG. 6 is a drawing representing electric field values over the front side of a mobile terminal when a coupling branch according to an embodiment of the present invention is used and when it is not used.

In FIG. 6, the electric field was measured in each of the nine grids, grids 1 through 9, into which the front side area that comes in contact with the human body was divided, and the electric field was measured for three channels 512, 661 and 810, in a PCS frequency band.

The standard electric field for maintaining an appropriate HAC in PCS band is set at 85V/m.

In FIG. 6, it may be confirmed that, when a coupling branch is not used, the electric field value in the central part of each channel is 135.2V/m, 129.5V/m and 114.8V/m respectively, meaning that a comparatively large electric field is created at the front side of a mobile terminal, and thus, an appropriate HAC cannot be maintained.

However, it may be confirmed that, when a coupling branch is used, electric field value in the central part of each channel is 85.2V/m, 82.0V/m and 59.9V/m respectively, which is close to or lower than the standard electric field value.

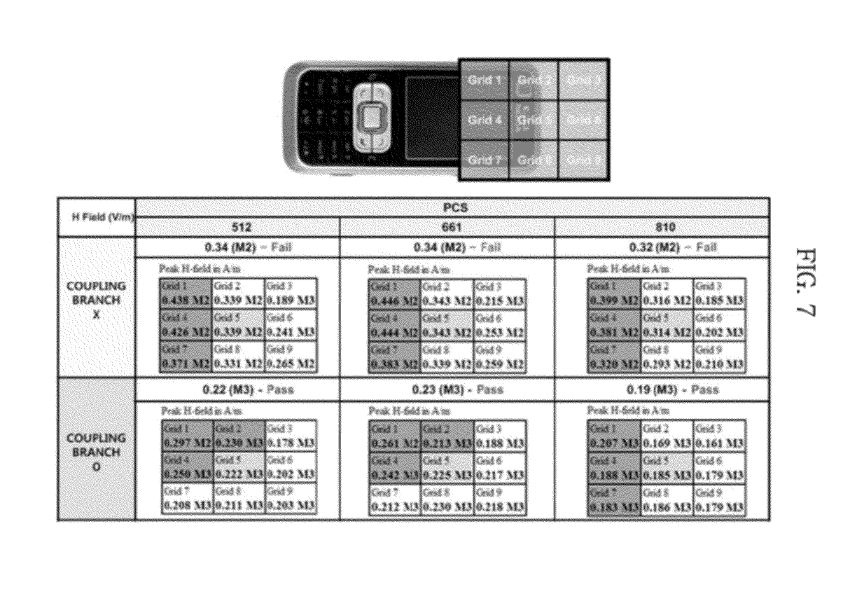

FIG. 7 is a drawing representing magnetic field values over the front side of a mobile terminal when a coupling branch according to an embodiment of the present invention is used and when it is not used.

Also in FIG. 7, the magnetic field was measured in each of the nine grids, grids 1 through 9, into which the front side area that comes in contact with the human body when talking on the phone was divided, and the magnetic field was measured for three channels 512, 661 and 810, in a PCS frequency band.

The standard magnetic field for maintaining an appropriate HAC in PCS band is set at 0.25 A/m.

In FIG. 7, it may be confirmed that, when a coupling branch is not used, the magnetic field value in the central part of each channel is 0.339 A/m, 0.343 A/m and 0.314 A/m respectively, meaning that a comparatively large magnetic field is created at the front side of a mobile terminal, and thus, an appropriate HAC cannot be maintained.

However, it may be confirmed that, when a coupling branch is used, the magnetic field value in the central part of each channel is 0.222 A/m, 0.225 A/m and 0.185 A/m respectively, which is close to or lower than the standard magnetic field value.

While the present invention has been described with reference to particular embodiments, it is to be appreciated that various changes and modifications may be made by those skilled in the art without departing from the spirit and scope of the present invention, as defined by the appended claims and their equivalents.

In particular, it should be apparent to those skilled in the art that, although the term “line” was used for conductors formed on carriers, they are not limited to linear forms, and may also include conductors in a patch form.

1. An antenna for a mobile terminal for improving SAR and HAC characteristics, the antenna comprising:
a first conductive line electrically connected to a feeding point;
a second conductive line separated from the first conductive line at a designated distance and electrically connected to a ground;
a third conductive line extending from the second conductive line; and
a coupling branch separated from the third conductive line and electrically connected to a ground,
wherein coupling matching and coupling feeding occur between the first conductive line and the second conductive line, and the second conductive line and the third conductive line operate as a radiator.

2. The antenna for a mobile terminal for improving SAR and HAC characteristics according to claim 1, wherein the coupling branch is arranged such that coupling occurs from a point at least 0.15λ from a starting end of the radiator.

3. The antenna for a mobile terminal for improving SAR and HAC characteristics according to claim 1, wherein the coupling branch comprises a coupling part and a ground connection part, the coupling part having coupling with the third conductive line occurring in a designated section thereof, the ground connection part connected to the ground.

4. The antenna for a mobile terminal for improving SAR and HAC characteristics according to claim 3, wherein the coupling branch further comprises an open stub for impedance matching.

5. The antenna for a mobile terminal for improving SAR and HAC characteristics according to claim 3, wherein multiple open stubs protrude between the coupling branch and the third conductive line from the coupling branch and the third conductive line, in the section where coupling occurs between the coupling branch and the third conductive line.

6. The antenna for a mobile terminal for improving SAR and HAC characteristics according to claim 5, wherein the open stubs protrude from the coupling branch and the third conductive line in an interlocking manner.

7. The antenna for a mobile terminal for improving SAR and HAC characteristics according to claim 5, wherein multiple open stubs protrude between the first conductive line and the second conductive line from the first conductive line and the second conductive line.

8. An antenna for a mobile terminal for improving SAR and HAC characteristics, the antenna comprising:
a feeding part;
a radiator configured to receive RF signals fed from the feeding part; and
a coupling branch separated from the radiator at a designated distance and having coupling occurring in a section thereof separated from the radiator, the coupling branch electrically connected to a ground.

9. The antenna for a mobile terminal for improving SAR and HAC characteristics according to claim 8, wherein the coupling branch is arranged such that coupling occurs from a point at least 0.15λ from a starting end of the radiator.

10. The antenna for a mobile terminal for improving SAR and HAC characteristics according to claim 9, wherein the coupling branch comprises a coupling part and a ground connection part, the coupling part having coupling with the radiator occurring in a designated section thereof, the ground connection part connected to the ground.

11. The antenna for a mobile terminal for improving SAR and HAC characteristics according to claim 9, wherein multiple open stubs protrude between the coupling branch and the radiator from the coupling branch and the radiator, in the section where coupling occurs between the coupling branch and the radiator.

12. The antenna for a mobile terminal for improving SAR and HAC characteristics according to claim 11, wherein the open stubs protrude from the coupling branch and the radiator in an interlocking manner.
